(19) United States
(12) Patent Application Publication
(10) Pub. No.: US 2024/0331904 A1
(43) Pub. Date: Oct. 3, 2024

(54) COIL COMPONENT

(71) Applicant: TDK CORPORATION, Tokyo (JP)

(72) Inventors: Hitoshi OHKUBO, Tokyo (JP); Hokuto EDA, Tokyo (JP); Masazumi ARATA, Tokyo (JP); Miyuki ASAI, Tokyo (JP); Takahiro HOSOKAWA, Tokyo (JP); Yuji MATSUURA, Tokyo (JP)

(73) Assignee: TDK CORPORATION, Tokyo (JP)

(21) Appl. No.: 18/616,465

(22) Filed: Mar. 26, 2024

(30) Foreign Application Priority Data
Mar. 29, 2023 (JP) 2023-053775

(51) Int. Cl. H01F 3/08; H01F 5/04

(52) U.S. Cl. CPC H01F 3/08; H01F 5/04

(57) ABSTRACT

Since each of an inner core, an outer core portion, and exterior portions in an element body is constituted by a magnetic body having the same material composition, internal stress is less likely to occur at the interface therebetween, and cracks due to internal stress are less likely to occur at the interface. Since a filling rate of a maximum magnetic particle having relatively high magnetic permeability is high in the inner core, the magnetic permeability of the inner core is significantly increased, and the coil characteristics of the coil component are improved.

### CROSS-REFERENCE TO RELATED APPLICATIONS

This application is based upon and claims the benefit of priority from Japanese Patent Application No. 2023-53775, filed on 29 Mar. 2023, the entire content of which is incorporated herein by reference.

### TECHNICAL FIELD

The present disclosure relates to a coil component.

### BACKGROUND

Japanese Patent Application Publication No. 2016-195245 discloses a coil component including a plate member located at inner core made of material different from an element body material in order to increase magnetic permeability of the inner core and improve coil characteristics.

### SUMMARY

In the above-described coil component according to the related art, there is large difference in material properties between the constituent material of the plate member and the element body material. For example, it is considered that the coefficient of thermal expansion of the constituent material of the plate member and that of the element body material are greatly different from each other, and thus internal stress is generated around the plate member, and cracks caused by the internal stress are generated in the element body.

According to various aspects of the present disclosure, there is provided a coil component in which cracks are suppressed.

A coil component according to one aspect of the present disclosure includes an element body made of material including a plurality of types of magnetic powders having different average particle diameters and resin, and a coil provided in the element body, wherein, in an inner core surrounded by the coil in the element body, a filling rate of a maximum magnetic particle having a maximum average particle diameter among the magnetic powders included in the element body is higher than a filling rate of a magnetic powder having a non-maximum average particle diameter.

In the coil component, a large difference in material properties does not occur at the interface between the inner core and the other portion of the coil in the element body, and cracks caused by internal stress are suppressed.

### BRIEF DESCRIPTION OF THE DRAWINGS

FIG. 1 shows a schematic perspective view of a coil component according to one embodiment.

FIG. 2 shows an exploded perspective view of the coil component shown in FIG. 1.

FIG. 3 shows an exploded perspective view of the configuration of the substrate and the coil conductor.

FIG. 4 shows a cross-sectional view taken along line IV-IV of the coil component shown in FIG. 1.

FIG. 5 shows a cross-sectional view taken along line V-V of the coil component shown in FIG. 1.

FIG. 6 shows a diagram of the distribution of magnetic powder in the element body.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

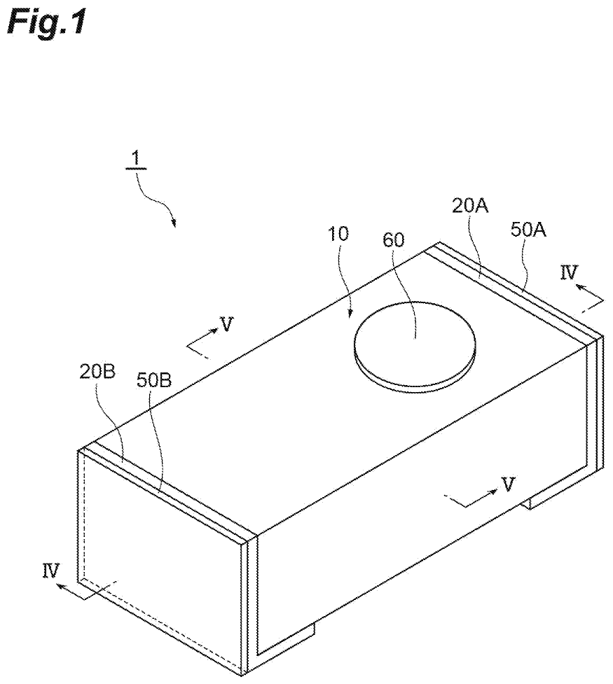

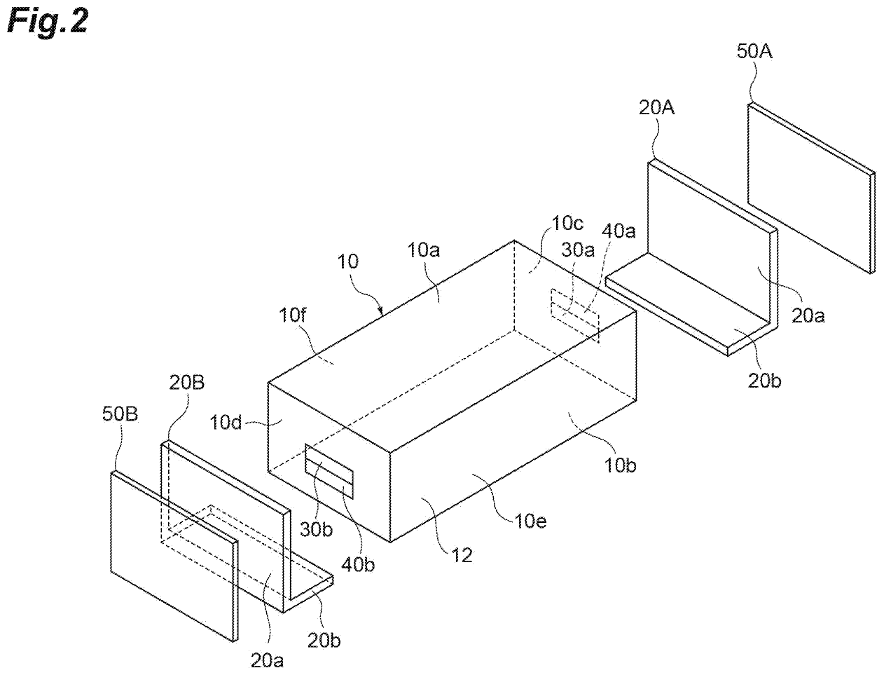

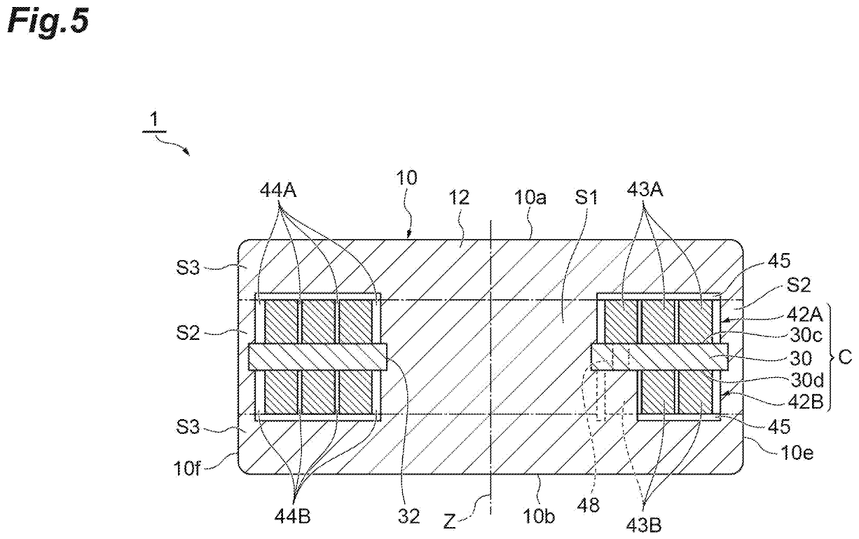

A coil component 1 according to one embodiment will be described with reference to FIGS. 1 to 5. As shown in FIGS. 1 and 2, the coil component 1 includes an element body 10, a pair of external terminal electrodes 20A and 20B provided on the surface of the element body 10, and a pair of insulation layers 50A and 50B covering the pair of the external terminal electrodes 20A and 20B from the outside.

The element body 10 has a substantially rectangular parallelepiped outer shape and includes a pair of main surfaces 10a and 10b facing each other and two pairs of side surfaces 10c to 10f extending in a direction intersecting each of main surfaces 10a and 10b to connect the main surfaces 10a and 10b. The two pairs of side surfaces 10c to 10f includes a pair of end surfaces 10c and 10d facing each other and a pair of side surfaces 10e and 10f facing each other. In the present embodiment, the facing direction of the pair of main surfaces 10a and 10b is the height direction of the element body 10, the facing direction of the pair of end surfaces 10c and 10d is the long side direction of the element body 10, and the facing direction of the pair of side surfaces 10e and 10f is the short side direction of the element body 10. In the present embodiment, the main surface 10b is a mounting surface facing a substrate on which the coil component 1 is mounted. The coil component 1, as an example, is designed with dimensions of a longer side 2.0 mm, a shorter side 1.25 mm, height 1.0 mm.

In the present embodiment, a mark 60 for determining the direction and polarity of the coil component 1 is provided at a position biased toward the end surface 10c on the main surface 10a. The pair of main surfaces 10a and 10b of the element body 10 may be entirely covered with an insulation layer to increase insulation of the surface.

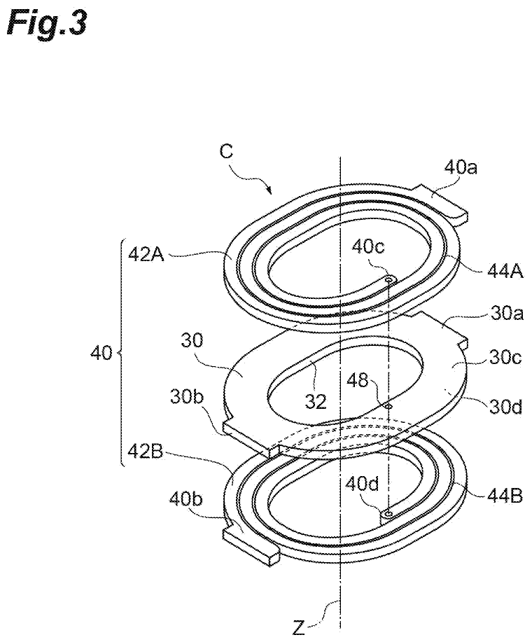

The element body 10 is configured to include a coil C having a substrate 30 shown in FIG. 3 and a coil conductor 40 provided inside a magnetic body 12.

The substrate 30 is provided inside the element body 10 and extends between the pair of end surfaces 10c and 10d in the element body 10. The substrate 30 has end portions 30a and 30b exposed from the end surfaces 10c and 10d. The substrate 30 has a flat plate shape extending parallel to the main surfaces 10a and 10b of the element body 10. The substrate 30 has an upper surface 30c located on the main surface 10a side and a lower surface 30d located on the main surface 10b side. The substrate 30 has a substantially elliptical annular shape when viewed from the thickness direction. An elliptical through hole 32 is provided in a central portion of the substrate 30.

The substrate 30 is made of nonmagnetic insulating material. As the substrate 30, substrate obtained by impregnating glass cloth with epoxy-based resin and having thickness of 10 μm to 60 μm can be used. In addition to the epoxy resin, BT resin, polyimide, aramid, or the like may be used. Ceramic or glass can also be used as the material of the substrate 30. The material of the substrate 30 may be mass-produced printed substrate material or resinous material used for BT printed-circuit board, FR4 printed-circuit board, or FR5 printed-circuit board.

The coil conductor 40 includes a first coil part 42A, a second coil part 42B, and a through-hole conductor 48. The first coil part 42A includes a first conductor pattern 43A insulation-coated for a planar air-core coil provided on the upper surface 30c of the substrate 30. The second coil part 42B includes a second conductor pattern 43B insulation-coated for a planar air-core coil provided on a lower surface 3d of the substrate 30. The through-hole conductor 48 connects the first conductor pattern 43A and the second conductor pattern 43B.

The first conductor pattern 43A is a planar spiral pattern serving as a planar air-core coil, and is formed by plating with conductor material such as Cu. The first conductor pattern 43A is configured to wind around the through hole 32 of the substrate 30. More specifically, as shown in FIG. 3, the first conductor pattern 43A is wound clockwise by three turns outward when viewed from above.

An outer end portion 40a of the first conductor pattern 43A is exposed at the end surface 10c of the element body 10 and is connected to the external terminal electrode 20A that covers the end surface 10c. An inner end portion 40c of the first conductor pattern 43A is connected to the through-hole conductor 48.

Similar to the first conductor pattern 43A, the second conductor pattern 43B has a planar spiral pattern serving as a planar air-core coil and is formed by plating with conductor material such as Cu. The second conductor pattern 43B is also configured to wind around the through hole 32 of the substrate 30. More specifically, the second conductor pattern 43B is wound counterclockwise by three turns outward when viewed from above. In other words, the second conductor pattern 43B is wound in a direction opposite to the first conductor pattern 43A when viewed from above.

An outer end portion 40b of the second conductor pattern 43B is exposed at the end surface 10d of the element body 10 and is connected to the external terminal electrode 20B that covers the end surface 10d. An inner end portion 40d of the second conductor pattern 43B is aligned with the inner end portion 40c of the first conductor pattern 43A in the thickness direction of the substrate 30 and connected to the through-hole conductor 48.

The through-hole conductor 48 is provided through the edge region of the through-hole 32 of the substrate 30, and connects the inner end portion 40c of the first conductor pattern 43A and the inner end portion 40d of the second conductor pattern 43B. The through-hole conductor 48 may consist of a hole provided in the substrate 30 and conductive material (for example, metallic material such as Cu) filled in the hole. The through-hole conductor 48 has, as an example, a columnar (e.g., cylindrical or prismatic) outer shape extending in the thickness direction of the substrate 30.

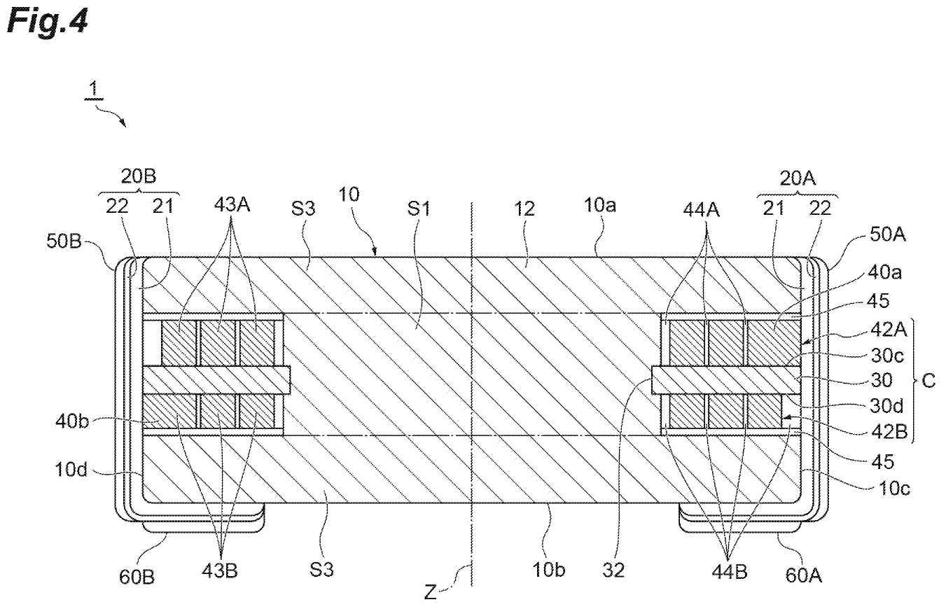

As shown in FIG. 4, the first coil portion 42A and the second coil portion 42B have resin walls 44A and 44B, respectively. The resin wall 44A of the first coil portion 42A is located between the wires of the first conductor pattern 43A, on the inner periphery and on the outer periphery of the wires of the first conductor pattern 43A. Similarly, the resin wall 44B of the second coil portion 42B is located between the wires of the second conductor pattern 43B, on the inner periphery and on the outer periphery of the wires of the second conductor pattern 43B. In the present embodiment, the resin walls 44A and 44B at the inner and outer peripheries of the conductor patterns 43A and 43B are designed to be thicker than the resin walls 44A and 44B located between the wires of the conductor patterns 43A and 43B.

The resin walls 44A and 44B are made of insulating resinous material. The resin walls 44A and 44B can be provided on the substrate 30 before the first conductor pattern 43A and the second conductor pattern 43B are formed, in which case the first conductor pattern 43A and the second conductor pattern 43B are plated and grown in areas defined by the resin walls 44A and 44B. The resin walls 44A and 44B can be provided on the substrate 30 after the first conductor pattern 43A and the second conductor pattern 43B are formed, and in which case, the resin walls 44A and 44B are formed by filling, coating or the like on the first conductor pattern 43A and the second conductor pattern 43B.

Each of the first coil portion 42A and the second coil portion 42B is provided with insulation layers 45 that integrally covers the first conductor pattern 43A, the second conductor pattern 43B, the resin walls 44A and 44B from above and below. The insulation layer 45 may be made of insulating resin or insulating magnetic material.

The magnetic body 12 integrally covers the substrate 30 and the coil C. The magnetic body 12 covers the substrate 30 and the coil C from above and below and covers the outer peripheries of the substrate 30 and the coil C. In other words, an inner core S1 of the coil C, an outer core S2 of the coil C, and exterior portions S3 sandwiching the coil C from above and below are filled with the magnetic body 12. The inner core S1 of the coil C is a portion surrounded by the coil C between the upper end of the first conductor pattern 43A and the lower end of the second conductor pattern 43B in a direction of the axis Z of the coil C. The magnetic body 12 that is located in the inner core S of the coil C fills the interior of the through-hole 32 in the substrate 30 and the inner area of the coil conductor 40. The outer core S2 of the coil C is a portion that is located in the same layer as the substrate 30, the conductor patterns 43A, and 43B of the coil C with respect to the vertical direction and surrounds the coil C from the outer periphery when viewed from the vertical direction. The exterior portions S3 is located above and below the coil C. In the present embodiment, the inner core S1 and the outer core S2 constitute the main surfaces 10a and 10b of the element body 10. In the present embodiment, the magnetic body 12 constitutes all surfaces of the element body 10, i.e. the main surfaces 10a and 10b, the end surfaces 10c and 10d, the side surfaces 10e and 10f.

The magnetic body 12 is made of a metal magnetic powder-containing resin. The metal magnetic powder-containing resin is a bound powder in which metal magnetic powder is bound by binder resin. The metal magnetic powder of the metal magnetic powder-containing resin constituting the magnetic body 12 includes a plurality of types of magnetic powders having different average particle diameters. In the present embodiment, the metal magnetic powder of the metal magnetic powder-containing resin constituting the magnetic body 12 includes three types of magnetic powder having different average particle diameters. Among the three types of magnetic powders, the magnetic powder having the maximum average particle diameter (maximum magnetic particle) has an average particle diameter of 15 to 35 μm as an example, and is made of Fe-amorphous alloy as an example. Among the three types of magnetic powders, a magnetic powder having a minimum average particle diameter (minimum magnetic particle) has an average particle diameter of 0.3 to 1.5 μm as an example, and is made of carbonyl iron as an example. Among the three types of magnetic powders, the magnetic powder having an average particle diameter between the maximum and the minimum has an average particle diameter of 1.5 to 10 μm as an example, and is made of Fe-amorphous alloy as an example. In the magnetic body 12, The magnetic permeability of the maximum magnetic particle is higher than the magnetic permeability of the minimum magnetic particle.

The metal magnetic powder of the metal magnetic powder-containing resin constituting the magnetic body 12 may contain metal magnetic powder containing Fe (e.g., iron-nickel alloy (i.e., permalloy), carbonyl iron, FeSiCr based alloy in state of amorphous, non-crystal or crystal, sendust, etc.). The binder resin is, as an example, a thermosetting epoxy resin. In the present embodiment, the content of the metal magnetic powder in the bounded powder is 80 to 92 vol % in terms of volume percent, and 95 to 99 wt % in terms of weight percent. From the viewpoint of magnetic properties, the content of the metal magnetic powder in the bound powder may be 85 to 92 vol % in terms of volume percent and 97 to 99 wt % in terms of weight percent.

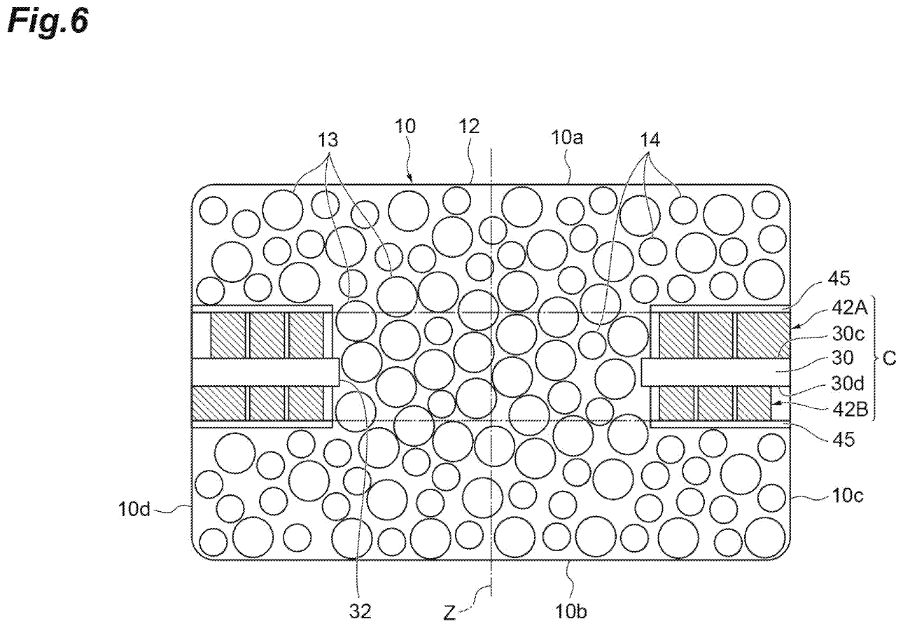

In the present embodiment, the metal magnetic powder of the metal magnetic powder-containing resin constituting the magnetic body 12 is distributed as shown in FIG. 6. In FIG. 6, only a maximum magnetic particle 13 and a minimum magnetic particle 14 are shown among the metal magnetic powders of the metal magnetic powder-containing resin constituting the magnetic body 12, and magnetic powders having an average particle diameter between the average particle diameter of the maximum magnetic particle 13 and the average particle diameter of the minimum magnetic particle 14 are omitted for convenience of explanation.

As shown in FIG. 6, in the inner core S1 of the element body 10, a rate of the magnetic body 12 in the maximum magnetic particle 13 (more specifically, a filling rate with respect to the magnetic powders constituting the magnetic body 12) is high. More specifically, in the inner core S1 in the element body 10, the rate of the maximum magnetic particle 13 in the magnetic body 12 is higher than the rate of the minimum magnetic particle 14 and higher than the rate of magnetic powder having an average particle diameter between the maximum and the minimum, not shown. Similar to the inner core S1 in the element body 10, the outer core S2 in the element body 10 also has a high rate (filling rate) of the maximum magnetic particle 13 in the magnetic body 12. On the other hand, in the exterior portions S3 in the element body 10, a filling rate of the minimum magnetic particle 14 in of the magnetic body 12 is high. More specifically, in the exterior portions S3 in the element body 10, the rate of the minimum magnetic particle 14 in the magnetic body 12 is higher than the rate of the maximum magnetic particle 13, and is higher than the rate of magnetic powder having an average particle diameter between the average particle diameter of the maximum magnetic particle 13 and the average particle diameter of the minimum magnetic particle 14 (not shown).

The distribution of the magnetic powders shown in FIG. 6 can be realized, for example, by configuring the element body material by dividing it into a plurality of times. For example, magnetic paste for metal magnetic powder-containing resin having a high rate of the maximum magnetic particle 13 may be applied to the coil C to form the inner core S1 and the outer core S2, and then magnetic paste having a high rate of the minimum magnetic particle 14 may be applied to the coil C to form the exterior portions S3, thereby implementing the magnetic powder distribution shown in FIG. 6.

Of the pair of the external terminal electrodes 20A and 20B, the first external terminal electrode 20A is provided on the end surface 10c side of the element body 10. The first external terminal electrode 20A includes a portion 20a covering a part or a whole of the end surface 10c and a portion 20b covering a part of the main surface 10b on the end surface 10c side, and has an L-shape continuously covering the end surface 10c and the main surface 10b.

Of the pair of the external terminal electrodes 20A and 20B, the first external terminal electrode 20A is provided on the end surface 10c side of the element body 10. The first external terminal electrode 20A includes a portion 20a covering a part or a whole of the end surface 10c and a portion 20b covering a part of the main surface 10b on the end surface 10c side, and has an L-shape continuously covering the end surface 10c and the main surface 10b.

Of the pair of the external terminal electrode 20A and 20B, the second external terminal electrode 20B is provided on the end surface 10d side of the element body 10. Similar to the first external terminal electrode 20A, the second external terminal electrode 20B includes a portion 20a covering a part or a whole of the end surface 10d and a portion 20b covering a part of the main surface 10b on the end surface 10d side, and has an L-shape continuously covering the end surface 10d and the main surface 10b. In the present embodiment, the portions 20a covering the end surfaces 10c and 10d of the external terminal electrodes 20A and 20B extend to height position reaching the upper ends of the end surfaces 10c and 10d. The portions 20a may not extend to the height position reaching the upper end of the end surfaces 10c and 10d.

Each of the external terminal electrodes 20A and 20B has a multilayer structure, and has a two-layer structure composed of a first electrode layer 21 and a second electrode layer 22 in the present embodiment. Each of the external terminal electrodes 20A and 20B may have a multilayer structure of three or more layers.

Each of the first electrode layers 21 is located on the surface of the element body 10 and directly covers the main surface 10b and the end surfaces 10c and 10d. Each of the first electrode layers 21 can be made of resinous electrode material, as an example. In the present embodiment, each of the first electrode layers 21 is an Ag-resin electrode made of resinous electrode material containing Ag powder. The first electrode layer 21 of the external terminal electrode 20A is in contact with and electrically connected to the outer end portion 40a of the first conductor pattern 43A exposed at the end surface 10c. The first electrode layer 21 of the external terminal electrode 20B is in contact with and electrically connected to the outer end portion 40b of the second conductor pattern 43B exposed at the end surface 10d.

Each of the second electrode layers 22 is located on the first electrode layer 21 and entirely cover the first electrode layer 21. Each of the second electrode layers 22 can be formed by metallic plating, as an example. In the present embodiment, each of the second electrode layers 22 is a Ni-plated electrode made of nickel. The resistivity of the second electrode layer 22 is designed to be lower than the resistivity of the first electrode layer 21.

The pair of the insulation layers 50A and 50B cover the portions 20a covering the end surfaces 10c and 10d of the external terminal electrodes 20A and 20B, respectively. In the present embodiment, each of the insulation layers 50A and 50B directly cover the second electrode layers 22 in the external terminal electrodes 20A and 20B. Each of the insulation layers 50A and 50B is made of insulating material such as resin.

In the pair of the external terminal electrodes 20A and 20B, since the portions 20a covering the end surfaces 10c and 10d are covered with the insulation layers 50A and 50B, the coil components 1 can be mounted at high density while avoiding an electric short circuit. Since the portions 20b covering the main surface 10b is not covered with the insulation layers 50A and 50B but exposed from the insulation layers 50A and 50B, surface mounting can be performed by using the portions 20b covering the main surface 10b of the external terminal electrodes 20A and 20B. In the present embodiment, as shown in FIG. 4, electrode layers 60A and 60B are provided on the portions 20b covering the main surface 10b of the external terminal electrodes 20A and 20B, respectively. Each electrode layer 60A and 60B can be used to further improve mountability, and can be formed of, as an example, a plated electrode (e.g., a Sn-plated electrode). By providing the electrode layers 60A and 60B after covering the external terminal electrodes 20A and 20B with the insulation layers 50A and 50B, the electrode layers 60A and 60B can be provided on a whole of the portions 20b of the external terminal electrodes 20A and 20B which are not covered with the insulation layer 50A and 50B.

In a pair of the external terminal electrode 20A and 20B, since the portion 20a covering the end surfaces 10c and 10d is covered with the insulation layers 50A and 50B, the coil component 1 can be mounted at high density while avoiding an electrical short circuit, and since the portion 20b covering the main surface 10b is not covered with the insulation layers 50A and 50B but exposed from the insulation layers 50A and 50B, surface mounting can be performed by using the portions 20b covering the main surface 10b of the external terminal electrodes 20A and 20B. In the present embodiment, as shown in FIG. 4, the electrode layers 60A and 60B are provided in the portions 20b covering the main surface 10b of the external terminal electrodes 20A and 20B, respectively. Each the electrode layer 60A and 60B can be used to further enhance mountability, and can be constituted by, for example, a plated electrode (as an example, a Sn-plated electrode). By providing the electrode layer 60A and 60B after covering the external terminal electrode 20A and 20B with the insulation layer 50A and 50B, the electrode layer 60A and 60B can be provided on the whole the portion 20b of the external terminal electrode 20A and 20B which are not covered with the insulation layer 50A and 50B.

In the coil component 1, the inner core S1, the outer core S2, and the exterior portions S3 of the element body 10 are all constituted by the magnetic body 12 made of the same material composition. Therefore, the inner core S1, the outer core S2 and the exterior portions S3 do not have a large difference in material properties, for example the coefficient of thermal expansion does not differ greatly. Therefore, internal stress is less likely to occur at the interface between the inner core S1, the outer core S2, and the exterior portions S3, and cracks due to internal stress are less likely to occur at the interface. Since the filling rate of the maximum magnetic particle having relatively high magnetic permeability is high in the inner core S1 in the element body 10, the magnetic permeability of the inner core S1 is significantly increased, and the coil characteristics of the coil component 1 are improved.

In addition, since the filling rate of the maximum magnetic particle having relatively high magnetic permeability is high in the outer core S2 in the element body 10, the magnetic permeability of the outer core S2 is significantly increased, and the coil characteristics of the coil component 1 are further improved.

The coil component described above is not limited to the configuration described above, and various configurations can be adopted. For example, the planar shape of the conductor pattern constituting the coil conductor is not limited to an elliptical shape, and may be, for example, a perfect circular shape or a polygonal shape.

What is claimed is:

1. A coil component comprising:
an element body made of material including a plurality of types of magnetic powders having different average particle diameters and resin; and
a coil provided in the element body;
wherein, in an inner core surrounded by the coil in the element body, a filling rate of a maximum magnetic particle having a maximum average particle diameter among the magnetic powders included in the element body is higher than a filling rate of a magnetic powder having a non-maximum average particle diameter.

2. The coil component according to claim 1, wherein, in portions sandwiching the coil with respect to an axis direction of the coil in the element body, a filling rate of a minimum magnetic particle having a minimum average particle diameter among the magnetic powders included in the element body is higher than a filling rate of a magnetic powder having a non-minimum average particle diameter.

3. The coil component according to claim 2, wherein magnetic permeability of the maximum magnetic particle is higher than magnetic permeability of the minimum magnetic particle.

4. The coil component according to claim 1, wherein the maximum magnetic particle is made of metal alloy.

5. The coil component according to claim 1, wherein, in an outer core located in the same layer as the coil with respect to the axis direction of the coil and surrounding the coil when viewed from the axis direction of the coil in the element body, the filling rate of the maximum magnetic particle having the maximum average particle diameter among the magnetic powders included in the element body is higher than the filling rate of the magnetic powder having the non-maximum average particle diameter.

6. The coil component according to claim 1, wherein the coil has a substrate, a first winding portion provided in a planar spiral on one main surface of the substrate, a second winding portion provided in a planar spiral on the other main surface of the substrate, and a through-portion piercing the substrate and connecting ends of the first winding portion and the second winding portion.
